(19) United States
(12) Patent Application Publication
(10) Pub. No.: US 2010/0040368 A1
(43) Pub. Date: Feb. 18, 2010

(54) METHOD AND SYSTEM FOR MANAGING OFF-NET VIRTUAL CONNECTIONS

(75) Inventors: Scott R. Kotrla, Wylie, TX (US); Christopher N. DelRegno, Rowlett, TX (US); Matthew W. Turlington, Richardson, TX (US); Michael U. Bencheck, Richardson, TX (US); Richard C. Schell, Allen, TX (US)

Correspondence Address: VERIZON;PATENT MANAGEMENT GROUP, 1320 North Court House Road, 9th Floor, ARLINGTON, VA, 22201-2909, US

(73) Assignees: Verizon Corporate Services Group Inc., Basking Ridge, NJ (US); Verizon Business Network Services Inc., Ashburn, VA (US)

(21) Appl. No.: 12/191,755

(22) Filed: Aug. 14, 2008

(51) Int. Cl. H04J 14/00; H04B 10/00

(52) U.S. Cl. 398/54; 398/98

(57) ABSTRACT

An approach is provided for managing off-network virtual connections. A first management channel is mapped to a second management channel for transport of management information over an optical time-division-multiplexing (TDM) network that includes an off-network portion. The off-network portion corresponds to a third party provider. The first management channel corresponds to an electrical connection and the second management channel corresponds to an optical connection.

### BACKGROUND INFORMATION

Telecommunication networks have evolved into a complex interplay of optical and electrical systems as well as multiple service providers for offering a host of communication services. These services range from plain-old-telephone service (POTS) to broadband data services. With the increase in demand for broadband communications and services, telecommunication service providers have engaged in greater deployment of optical networks, which need to interface with existing and developing technologies. Typically, these optical communication networks utilize multiplexing transport techniques, such as time-division multiplexing (TDM), wavelength-division multiplexing (WDM), and the like, for transmitting information over optical fibers. However, an increase in demand for more flexible, resilient transport is driving optical communication networks toward high-speed, large-capacity packet-switching transmission techniques that enable switching and transport functions to occur in completely optical states via one or more packets. As such, this technological innovation carries with it a new burden to provision and manage reliable service over these networks, i.e., service that is capable of withstanding link and node failure while also maintaining high transmission capacity. As a result, traffic management and engineering plays an important role in providing high network reliability and performance. However, given that a multitude of network service providers operate using various infrastructures and protocols, there is a continual challenge for telecommunication service providers to manage communication paths across these different systems. Coordination across multiple service providers is a particular challenge in that these service providers need to be concerned with security and control, which can complicate the sharing of information for proper traffic management.

Therefore, there is a need for an approach that provides for effective and efficient management of traffic across multiple networks.

### BRIEF DESCRIPTION OF THE DRAWINGS

Various exemplary embodiments are illustrated by way of example, and not by way of limitations in the figures of the accompanying drawings in which like reference numerals refer to similar elements and in which:

FIGS. 1A and 1B are diagrams, respectively, of an optical node configured to map management channels, and an Add-Drop Multiplexer (ADM)/Packet Processing component utilized in the optical node, according to an exemplary embodiment;

FIG. 2 is a flowchart of a process for managing virtual connections across a third party network, according to an exemplary embodiment;

FIG. 3 is a diagram of an exemplary communication system providing management of on-network time division multiplexing (TDM)-based connections;

FIG. 4 is a diagram of an exemplary communication system supporting Virtual Local Area Network (VLAN) management and data communications channel (DCC) management involving on-network time division multiplexing (TDM)-based connections;

FIGS. 5A and 5B are diagrams of communication systems supporting VLAN management and DCC management involving on-network/off-network TDM-based connections, according to an exemplary embodiment;

FIG. 6 is a diagram of a communication system providing management of on-network/off-network TDM-based connections utilizing a mapping interface between a DCC management domain and a VLAN management domain, according to an exemplary embodiment; and

FIG. 7 is a diagram of a computer system that can be used to implement various exemplary embodiments.

### DESCRIPTION OF THE PREFERRED EMBODIMENT

A preferred apparatus, method, and software for managing off-net virtual connections are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although the various exemplary embodiments are described with respect to Ethernet technology and time division multiplexing (TDM), it is contemplated that the various exemplary embodiments are also applicable to other equivalent technologies and transmission schemes.

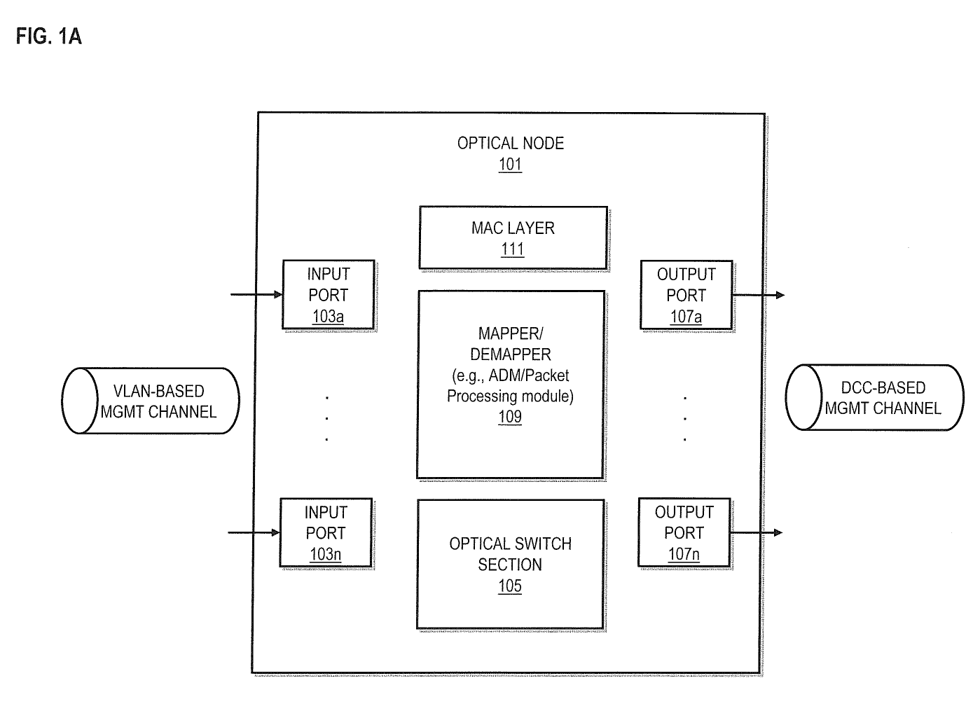

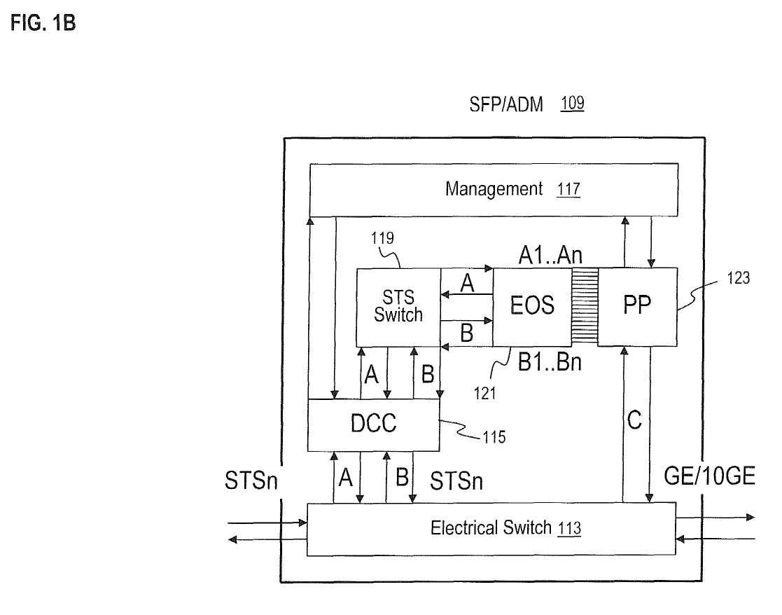

FIGS. 1A and 1B are diagrams, respectively, of an optical node configured to map management channels, and an Add-Drop Multiplexer (ADM)/Packet Processing component utilized in the optical node, according to an exemplary embodiment. As shown, optical node 101 includes input ports 103a-103n for interfacing electrical and/or optical connections, and an optical switch section 105 that directs traffic to an appropriate output port 107a-107n. According to one embodiment, the input ports input ports 103a-103n can be implemented as line cards to serve as “n” input interfaces (ingress points) to optical node 101 from “n” transmitting sources, while output ports (e.g., line cards) act as “n” output interfaces (egress points) from optical node 101 to “n” destination nodes. For the purposes of illustration, the optical node 101 utilizes time division multiplexing (TDM) and is part of an optical network, e.g., synchronous optical network (SONET) or optical transport network (OTN).

Under this scenario, a mapper/demapper 109 provides a mapping function between two different management channels (or domains), such as a virtual local area network (VLAN)-based management channel and a data communications channel (DCC)-based management channel. In certain embodiments, the mapper/demapper 109 is implemented using an Add-Drop Multiplexer (ADM)/Packet Processing module. In one embodiment, this ADM/Packet Processing module resides on a line card; alternatively, this module can be implemented as a SFP (small form factor pluggable).

DCC provides an inband data communication channel in a synchronous optical network/synchronous digital hierarchy (SONET/SDH) system. By way of example, the system 500 employs a SONET/SDH frame; as such, the frame includes, for instance, two types data communication channels: Section DCC and Line DCC. The Section DCC and Line DCC transport management messages between network elements as well as between network elements and a management system, respectively. With DCC, the service provider can readily manage SONET/SDH network elements.

By way of example, the optical node 101 supports a TDM-based Ethernet private line (EPL); accordingly, a medium access control (MAC) layer 111 function is utilized. Ethernet Private Line (EPL) is a data service that provides a point-to-point Ethernet connection between a dedicated physical interfaces (i.e., User-Network Interfaces (UNIs)), as defined by the Metro Ethernet Forum. EPL can be implemented as a point-to-point Ethernet Virtual Connection (EVC). It is contemplated that other communication paths can be utilized, such as Ethernet Virtual Private Line (EVPL). In contrast to EPL, Ethernet Virtual Private Line (EVPL) permits service multiplexing. With EVPL, a dedicated physical interface is used to accept all service frames, which can be multiplexed to a single EVC (denoted as “bundling”).

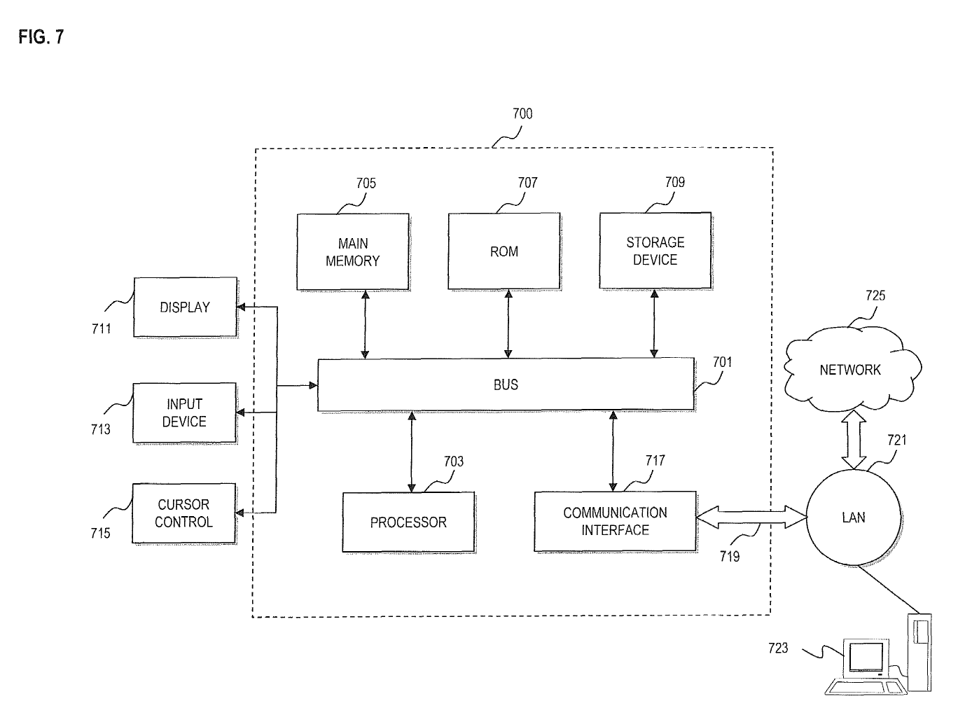

It is contemplated that optical node 101 may embody many forms (e.g., add/drop multiplex (ADM)). For example, optical node 300 may comprise computing hardware (such as described with respect to FIG. 7), as well as include one or more components configured to execute the processes described herein for mapping between the VLAN-based management channel and the DCC-based management channel. Additionally, it is contemplated that the components of optical node 101 may be combined, located in separate structures, or separate physical locations.

It is noted that service providers, in general, attempt to manage TDM-based virtual connections (e.g., Ethernet Private Lines (EPLs)) or Ethernet devices across third party networks without having to go through a packet fabric to groom management VLANs to the management network. Furthermore, for the Ethernet encapsulation conversion functionality, service providers seeking to peer with other service providers at the SONET layer for Ethernet services typically use different encapsulation technologies.

As seen in FIG. 1B, an ADM/Packet Processing component 109 includes an electrical switch 113 for switching, for example, two of three internal inputs (SONET A, SONET B, and Ethernet C) to electrical and optical external outputs. The electrical switch 113 can be initially configured with both electrical and optical interfaces to SONET until a DCC peer is found. A DCC module 115 is accordingly provided. The remaining configuration can thus be received over the DCC module 115; such configuration information can then be stored in, e.g., non-volatile memory (not shown).

The DCC module 115 maps, for instance, IP DCC from SONET channels to an internal management function module 117. The DCC module 115 can also process other SONET overhead as well as manage alarms and PMs.

The ADM/Packet Processing module 109 additionally includes an STS switch 119 for mapping Ethernet STS channels to Ethernet over SONET (EOS) functions. Also, the ADM/Packet Processing module 109 maps non-Ethernet STS channels from one SONET port to another.

An EOS module 121 communicates with the STS switch 119 supports encapsulating/de-encapsulating of Ethernet into n SONET Virtual Concatenation Groups for SONET A and the same for SONET B. In one embodiment, the EOS module 121 supports multiple encapsulation protocols (e.g. GFP, X.86) and supports multiple VCG types (contiguous concatenation, STS1-nv, STS3c-nv, etc.).

Moreover, the ADM/Packet Processing component 109 includes a packet processing (PP) module 123 for executing packet processing function. For instance, the PP module 123 provides 2*n connections from EOS module 121 (A1 . . . An, B1 . . . Bn) and one connection from GE/10GE port (C). The PP module 123 can also collect packet statistics, and filter out IP management VLAN from each connection and passing to internal management function. In this example, non-management traffic can be routed from A1 to B1, A1 to C, or B1 to C based on configuration. Also, non-management traffic goes from A2 to B2, A3 to B3 . . . An to Bn.

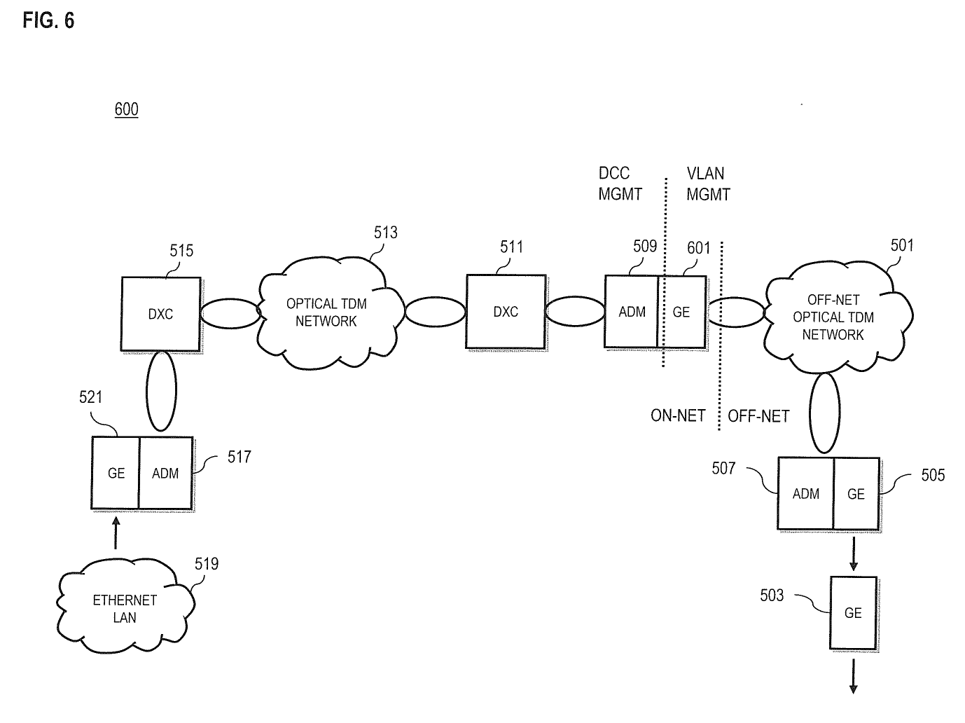

It is contemplated that the functional modules of ADM/Packet Processing component 109 may be combined, located in separate structures, or separate locations. Furthermore, in certain embodiments, these functions can reside within an Ethernet card (e.g., GE card), or other equivalent network interfaces; this scenario is depicted in FIG. 6, for example.

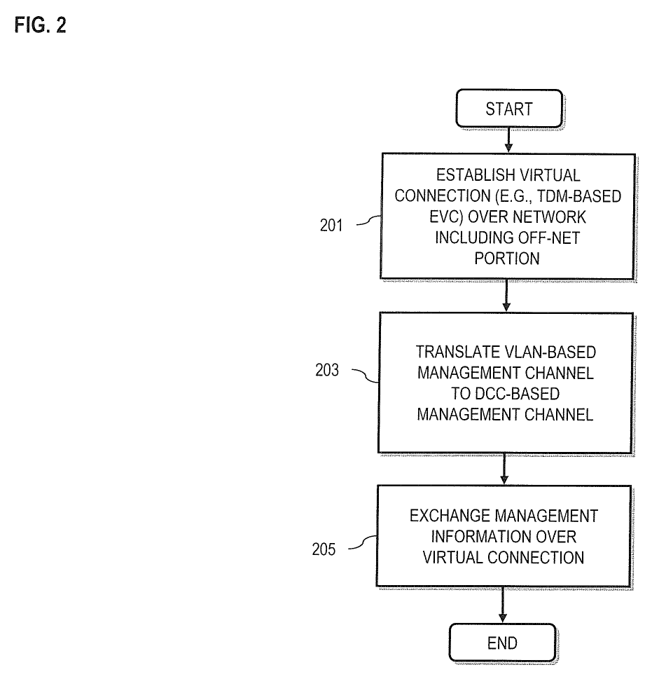

FIG. 2 is a flowchart of a process for managing virtual connections across a third party network, according to an exemplary embodiment. In step 201, a virtual connection, such as a TDM-based Ethernet Private Line (EPL) EVC, is established over a network that includes a portion that is associated with a third party. This third party network is deemed an “off-network (or off-net)” portion of the communication path supporting the virtual connection.

Traditionally, TDM-based EVCs are provisioned over SONET ADMs and managed using DCC. This arrangement is suitable within the network of single carrier (or service provider). However, if part of the communication path (e.g., circuit) is over another carrier's network (off-net), DCC is typically disabled at the handoff to the other network provider for security purposes. TDM-based EPLs can also be managed using an in-band management VLAN; unfortunately, this requires running the EVC through a packet switch to change management to the management network and the customer traffic to the correct end location. This approach is not cost-effective, as the addition of a packet switch is needed for the sole purpose of performing management.

In step 203, the optical node 101 translates the VLAN-based management channel to the DCC-based management channel. In an exemplary embodiment, the node 101 permits management of TDM-based Ethernet Private Line (EPL) EVCs across third party networks when DCC is not available by mapping, via the mapper 109, a VLAN-based management channel to a DCC-based management channel. At this point, management information can be exchanged over the virtual connection, as in step 205.

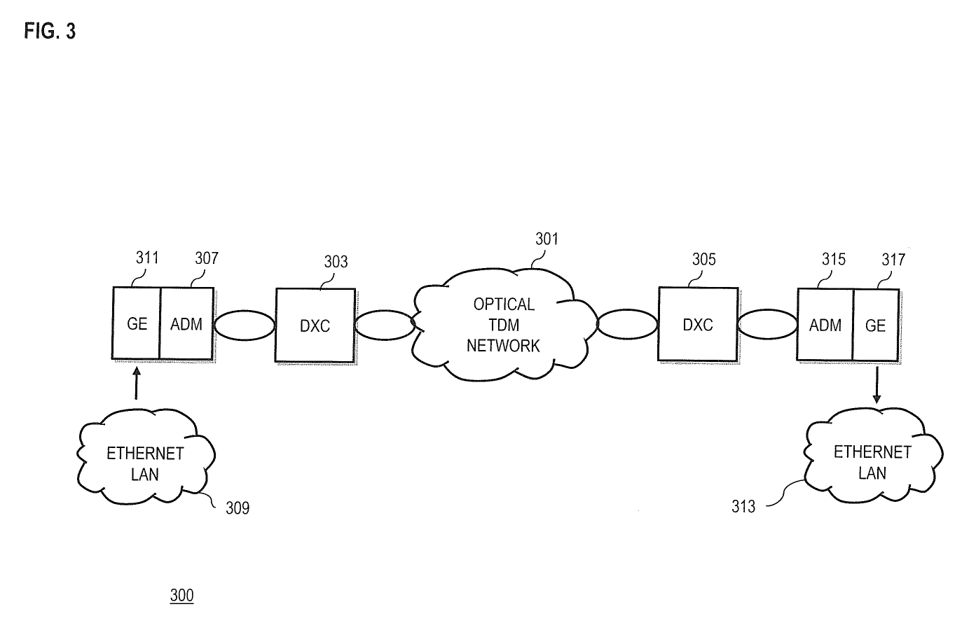

FIG. 3 is a diagram of an exemplary communication system providing management of on-network time division multiplexing (TDM)-based connections. In this example, communication system 300 is operated by a single service provider (or carrier) and includes a TDM network 301. The network 301 provides optical connections (e.g., Optical Carrier (OC)-192 or 10 Gbps) to digital cross-connects (DXC) 303 and 305. DXC 303 has connectivity to an add/drop multiplexer (ADM) 307, which interfaces with a local area network (LAN) 309—e.g., gigabit Ethernet (GE) LAN. This LAN 309 operates, for example, at 1 Gbps. The connection between the DXC 303 and the ADM 307 can be at a lower rate, such as OC-48 (2.488 Gbps). The ADM 307 couples to a GE network element 311. The ADM 307 may be a SONET ADM.

Under this arrangement, an Ethernet private line (EPL) can be established from a source node (not shown) on the LAN 309 over the TDM network 301 to a destination node on an Ethernet LAN 313. The DXC 305 attaches to the TDM network 301 over an OC-192 connection; in turn, the DXC 305 can employ an OC-48 link to an ADM 315. A GE network element 317 serves the LAN 313. Within each of the GE network elements 311, 317, a 1 Gbps Ethernet virtual connection (EVC) can be mapped to STS3c-7v GFP.

The EPL can be managed using VLAN management and DCC management channels, as next described.

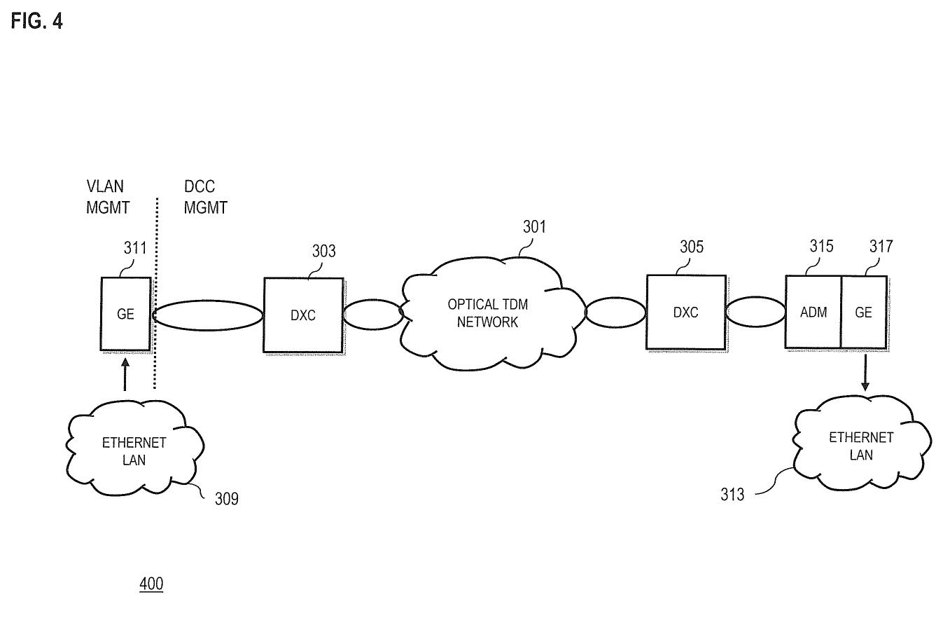

FIG. 4 is a diagram of an exemplary communication system supporting Virtual Local Area Network (VLAN) management and data communications channel (DCC) management involving on-network time division multiplexing (TDM)-based connections. In this example, the architecture of communication system 400 differs from that of system 300 (FIG. 3) by the removal of the ADM 307. The GE network element 311 can provide a SFP with electrical GE and VLAN management. The OC-48 connection can support STS3c-7v and DCC management.

Similar to the system 300, system 400 is under the management of a single carrier. As mentioned, under a single carrier scenario, the management of the EPL over the system 300 is not problematic in that the DCC feature is not disabled. However, if the communication path traverses a third party network (i.e., “off-net”), then management using DCC is not generally provided because of security concerns.

In system 400, the ADM/Packet Processing module 109 of FIG. 1B can reside in the ADM 315. Table 1 shows an exemplary ADM/Packet Processing configuration:

TABLE 1

Electrical = Ethernet C, GE
Optical = SONET A, STS48
EOS A1 = GFP STS3c-7v, starting at STS#1
PP 123 filters out management VLAN 4094 from C and send to
management function module 117, which maps to DCC 115 on
SONET A
PP 123 connects ports A1 and C

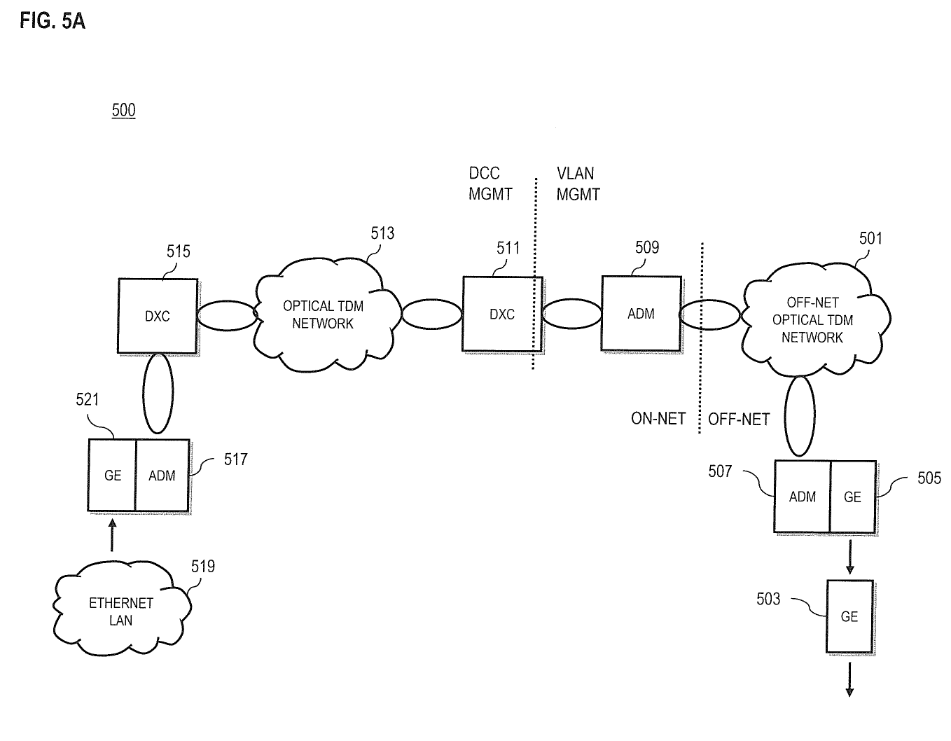

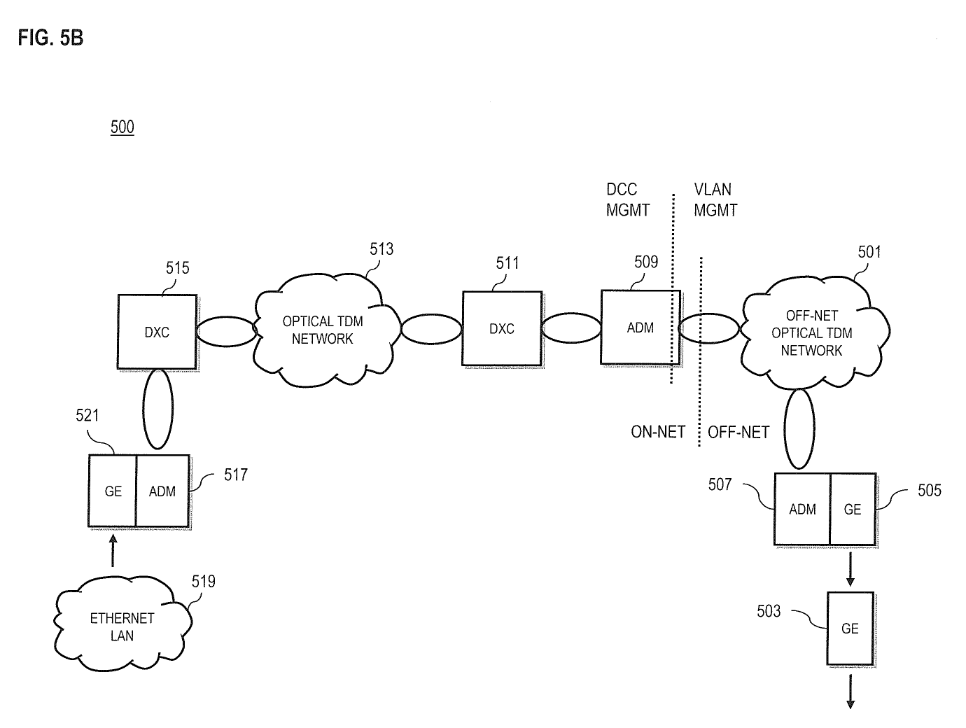

FIGS. 5A and 5B are diagrams of communication systems supporting VLAN management and DCC management involving on-network-/off-network TDM-based connections, according to an exemplary embodiment. As seen in FIG. 5A, communication system 500 employs an off-net optical TDM network 501 to reach GE network element 503 via another GE network element 505, which is coupled to an ADM 507. The ADM 507 has connectivity to the off-net optical TDM network 501 over, e.g., an OC-48 connection. The components 503, 505, 507, 509 and network 501 can operate, for example, under the VLAN management domain. It is noted that the ADM 509 is on-net, but within the VLAN management domain. The other network portions governed by the service provider operate under the DCC management domain. This network portion includes an ADM 509 that can utilize an optical link (e.g., OC-48) to access the off-net optical TDM network 501 and an OC-192 link to a DXC 511. The DXC 511 has connectivity to an optical TDM network 513, which communicates with another DXC 515. The DXC 515 utilizes, for example, an OC-48 connection to an ADM 517, which interfaces with a LAN 519 over a GE network element 521.

In FIG. 5B, the communication system 500, alternatively, extends the DCC management to the ADM 509.

Noting the problem with connection management involving use of a third party network (e.g., off-net optical TDM network 501), it is recognized that the mapping of different management channels is needed. Accordingly, communication system 500 introduces a mapping function (as described in FIG. 1), whereby a network element can map a VLAN-based management channel to a DCC-based management channel (or GCC in an OTN network). In this manner, the system 500 can tunnel management across the off-net portion of the system 500 as a VLAN, and then translate the VLAN-based management channel to a DCC-based management channel at a convenient point within the on-network portion of the system 500. This would eliminate the need for running the EVC through a packet switch (which is required in one conventional approach).

Tables 2 and 3 show exemplary configurations of the ADM/Packet Processing module 109 deployed in the system 500:

TABLE 2

Electrical = SONET A, STS48
Optical = SONET B, STS48
EOS A1, B1 = GFP STS3c-7v, starting at STS#1
PP 123 filters out management VLAN 4094 from B1 and sends to
management function module 117, which maps to DCC 115 on
SONET A
PP 123 connects ports A1 and B1
STS#22-48 pass between SONET A and SONET B unchanged

TABLE 3

Electrical = SONET A, STS12
Optical = SONET B, STS12
EOS A1 = GFP STS12c, starting at STS#1
EOS B1 = GFP STS1-12v, starting at STS#1
PP 123 filters out management VLAN 4094 from B1 and sends to
management function module 117, which maps to DCC 115 on
SONET A
PP 123 connects ports A1 and B1

FIG. 6 is a diagram of a communication system providing management of on-network/off-network TDM-based connections utilizing a mapping interface between a DCC management domain and a VLAN management domain, according to an exemplary embodiment. In this scenario, communication system 600 resembles that of system 500; however, in system 600, a GE network element 601 is utilized with the ADM 509. To operate with legacy equipment, the mapping functionality, in one embodiment, is incorporated into a SFP (e.g., of the GE network element 601) with an electrical connection to a VLAN-based management segment and an optical connection to a DCC-based management segment or vice versa. The electrical connection could be GE or Ethernet GFP over SONET at a standard SONET rate, while the optical connection could be SONET or OTN at a fixed rate based on the network equipment it needed to interface to.

In system 600, the functionality of the ADM/Packet Processing module 109 of FIG. 1B can be implemented within the GE 601. Table 4 shows an exemplary configuration of GE 601:

TABLE 4

GE card 601 includes Ethernet C, PP and EOS functions for
SONET A
Management and STS Switch functions reside outside of the GE
card 601 with connections via backplane

In the off-net scenarios of FIGS. 5 and 6, carriers typically require visibility to a device between the third party and the customer for troubleshooting and operational purposes. According to one embodiment, the SFP can include functionality for mapping from one type of encapsulation to another (e.g., X.86 to GFP, STS12c GFP to STS3c-4v GFP, STS3c-4v GFP to STS1-12v GFP).

The processes described herein for mapping management channels may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 7 illustrates computing hardware (e.g., computer system) 700 upon which an embodiment according to the invention can be implemented. The computer system 700 includes a bus 701 or other communication mechanism for communicating information and a processor 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to an embodiment of the invention, the processes described herein are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement the embodiment of the invention. Thus, embodiments of the invention are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an embodiment of the invention through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
mapping a first management channel to a second management channel for transport of management information over an optical time-division-multiplexing (TDM) network that includes an off-network portion, the off-network portion being associated with a third party provider,
wherein the first management channel corresponds to an electrical connection and the second management channel corresponds to an optical connection.

2. A method according to claim 1, wherein the first management channel is a virtual local area network (VLAN)-based management channel, and the second management channel is a data communications channel (DCC)-based management channel.

3. A method according to claim 1, further comprising:
establishing a point-to-point connection over the TDM network to an optical node, wherein the point-to-point connection is an Ethernet Virtual Connection.

4. A method according to claim 1, wherein the optical node is a synchronous optical network (SONET) add/drop multiplexer (ADM).

5. A method according to claim 4, wherein the electrical connection includes either Gigabit/Second Ethernet (GE) or Ethernet Generic Framing Procedure (GFP) over SONET at a standard SONET rate, and the optical connection includes a SONET connection or an Optical Transport Network (OTN) connection.

6. A method according to claim 1, wherein the mapping step is executed by a small form factor pluggable (SFP) component residing on an optical node of the network.

7. An apparatus comprising:
a mapping module configured to map a first management channel to a second management channel for transport of management information over an optical time-division-multiplexing (TDM) network that includes an off-network portion, the off-network portion being associated with a third party provider,
wherein the first management channel corresponds to an electrical connection and the second management channel corresponds to an optical connection.

8. An apparatus according to claim 7, wherein the first management channel is a virtual local area network (VLAN)-based management channel, and the second management channel is a data communications channel (DCC)-based management channel.

9. An apparatus according to claim 7, further comprising:
an optical switch section configured to establish a point-to-point connection over the TDM network to an optical node, wherein the point-to-point connection is an Ethernet Virtual Connection.

10. An apparatus according to claim 7, wherein the optical node is a synchronous optical network (SONET) add/drop multiplexer (ADM).

11. An apparatus according to claim 10, wherein the electrical connection includes either Gigabit/Second Ethernet (GE) or Ethernet Generic Framing Procedure (GFP) over SONET at a standard SONET rate, and the optical connection includes a SONET connection or an Optical Transport Network (OTN) connection.

12. A device comprising:
an electrical switch coupled to an electrical interface and an optical interface;
a data communications channel (DCC) module coupled to the electrical switch and configured to process a DCC-based management channel;
an optical switch coupled to the DCC module;
a encapsulation module coupled to the optical switch and configured to encapsulate one type of frame format into another type of frame format;
a packet processing module coupled to the encapsulation module and configured to filter a virtual local area network (VLAN)-based management channel; and
a management module coupled to the packet processing module and configured to map the VLAN-based management channel and to the DCC-based management channel.

13. A device according to claim 12, wherein the optical interface has connectivity to a third party network.

14. A device according to claim 13, wherein DCC functionality is disabled within the third party network.

15. A device according to claim 12, wherein the electrical interface complies with either Gigabit/Second Ethernet (GE) or Ethernet Generic Framing Procedure (GFP).

16. A device according to claim 12, wherein the device is a small form factor pluggable (SFP) component.

17. A device according to claim 16, wherein the device resides on a synchronous optical network (SONET) add/drop multiplexer (ADM) or a Gigabit Ethernet (GE) card.

18. A device according to claim 12, wherein the VLAN-based management channel provides management of an Ethernet Virtual Connection.

19. A device according to claim 18, wherein the VLAN-based management channel provides management of the Ethernet Virtual Connection without use of a packet switch.

20. A device according to claim 18, wherein the one type of frame format is an Ethernet frame, and the other type of frame format is a synchronous optical network (SONET) frame
